(19) United States
(12) Patent Application Publication
(10) Pub. No.: US 2016/0161354 A1
(43) Pub. Date: Jun. 9, 2016

(54) CALIBRATION TOOL FOR TORQUE WRENCH

(71) Applicant: Zheng-Cong Jiang, Taichung City (TW)

(72) Inventor: Zheng-Cong Jiang, Taichung City (TW)

(21) Appl. No.: 14/562,764

(22) Filed: Dec. 7, 2014

(51) Int. Cl. G01L 25/00

(52) U.S. Cl. CPC G01L 25/003

(57) ABSTRACT

A calibration tool for a torque wrench includes a measuring head and a deflecting lever. On the deflecting lever are a signal processing unit, a communication unit and a calibration unit. The measuring head has a transducer configured to have a head portion of the torque wrench coupled thereto. The transducer generates measured signals during the calibration. The deflecting lever is provided for exerting a torque on the head portion of the torque wrench. The signal processing unit is electrically coupled to the transducer for processing the measured signals of the transducer. The communication unit associates with a data storage of the torque wrench for a data exchange therebetween. And the communication unit reads out the data storage of the torque wrench for obtaining a preset torque of the torque wrench for a release. The calibration unit calibrates the torque wrench by comparison of the torque exerted in the moment of the release to the preset torque at the torque wrench.

### BACKGROUND OF THE INVENTION

1. Field of the Invention

The present invention relates to an instrument or tool for calibrating a torque wrench, and more particularly to a portable torque wrench calibration tool for convenient use.

2. Description of the Related Art

A torque wrench is typically used to exert a given torque on screws or nuts. In order to measure the exerted torque, the torque wrench is provided with a measuring device. With further devices, the measured torque is continuously displayed or the reaching of a given torque is indicated. Unfortunately, the measuring device of a torque wrench is normally subjected to common wear and tear symptoms. The torque wrench must be calibrated from time to time with an instrument to check if a torque measured with the measuring device is the same as an exerted torque.

A background art search directed to the subject matter of this invention conducted in the United States Patent and Trademark Office disclosed the following U.S. Pat. Nos.: 2,955,454; 4,171,647; 5,181,425 and 7,594,446. All of the patents found in the search are directed to a torque tester that is huge in size, complicated in structure and expensive in cost, and therefore is inconvenient for personal use.

### SUMMARY OF THE INVENTION

Accordingly, it is an object of the present invention to provide a portable calibration tool for calibrating a torque wrench to satisfy the aforementioned need. The calibration tool includes a measuring head and a deflecting lever extending from the measuring head. The measuring head has a transducer configured to have a head portion of the torque wrench coupled thereto. The transducer generates measured signals during the calibration. The deflecting lever is provided for exerting a torque on the head portion of the torque wrench. The signal processing unit is disposed in the deflecting lever and electrically coupled to the transducer for processing the measured signals of the transducer. The communication unit associates with a data storage of the torque wrench for a data exchange therebetween. The communication unit reads out the data storage of the torque wrench for obtaining a preset torque of the torque wrench for a release. Moreover, the calibration unit is configured to calibrate the torque wrench by comparison of the torque exerted in the moment of the release to the preset torque at the torque wrench. Besides, an alarm may be employed on the deflecting lever and set to make a sound in the moment of the release. In such a manner, the calibration tool can be sized substantially similar to a torque wrench and therefore is portable for convenient use.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 is a side view of a calibration tool and a torque wrench to be calibrated in accordance with the preferred embodiment of the present invention;

FIG. 2 is a perspective view of the calibration tool and the torque wrench shown in FIG. 1;

FIGS. 3-4 are perspective view of the calibration tool and the torque shown in FIG. 1, showing the calibration process; and

FIG. 5 is a view similar to FIG. 4, showing that an alarm of the calibration tool is actuated in the moment of a release of the torque wrench.

### DETAILED DESCRIPTION OF EMBODIMENTS

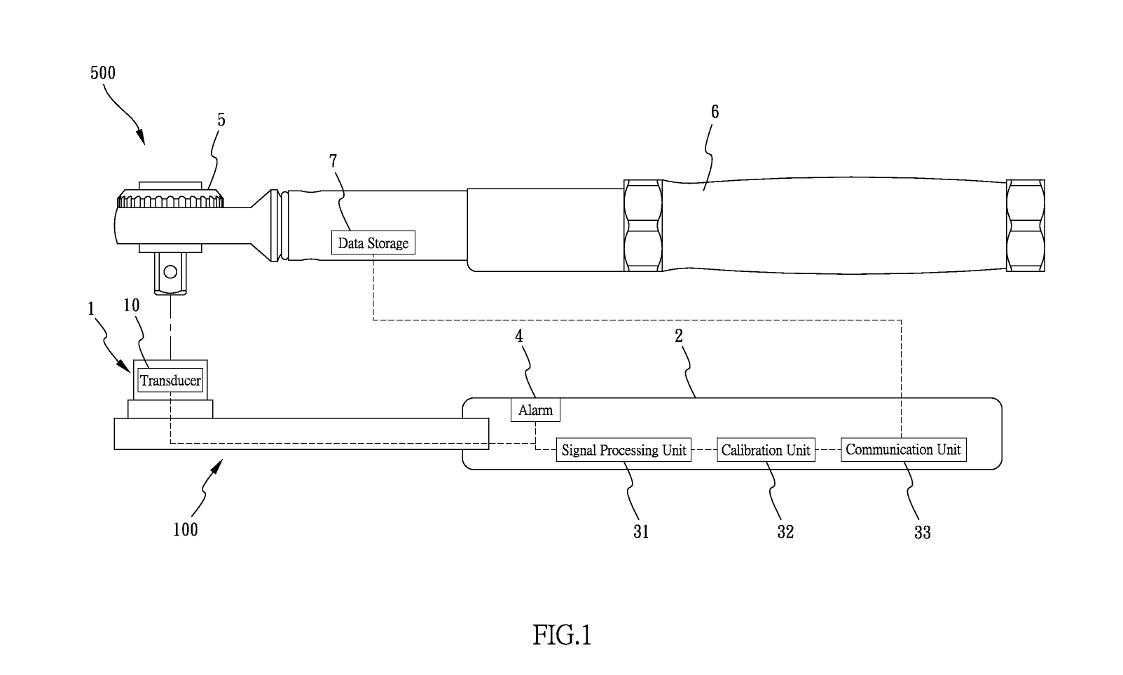

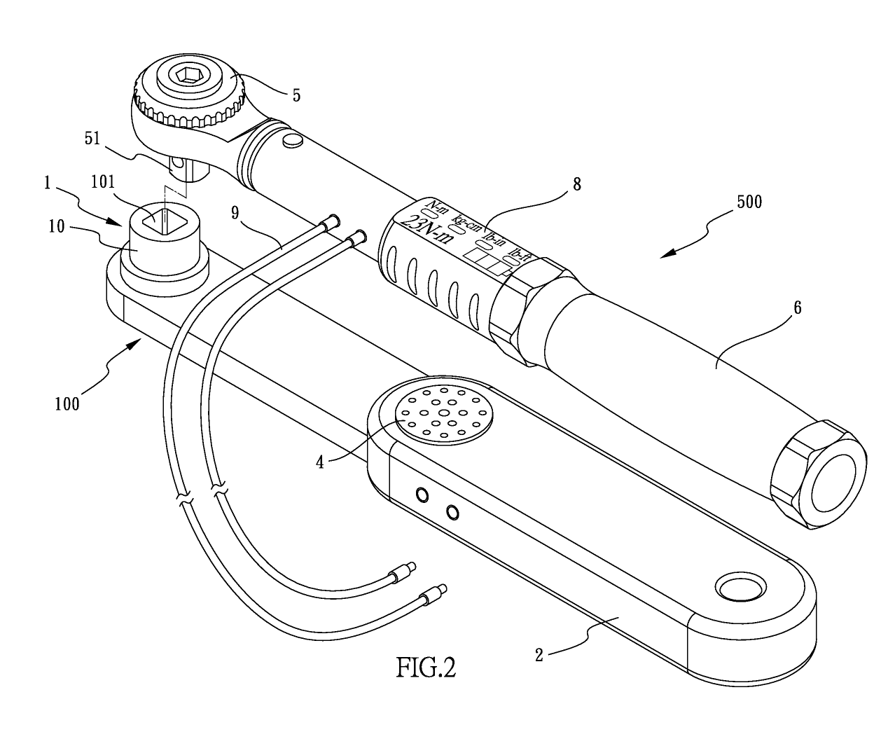

Referring to FIG. 1, there is shown a calibration tool 100 as well as an electronic torque wrench 500 to be tested by the calibration tool 100. Specifically, the calibration tool 100 is provided for automatically calibrating the torque wrench 500 or testing the accuracy of the torque wrench 100. The torque wrench 500 generally has a head portion 5 and a grip 6 extending in a longitudinal direction.

The calibration tool 100 includes a measuring head 1, a deflecting lever 2, and a control system having a signal processing unit 31, a calibration unit 32 and a communication unit 33 in the deflecting lever 2. More specifically, the measuring head 1 has a transducer 10 configured to have the head portion 5 of the torque wrench 500 coupled thereto. The deflecting lever 2 extends from the measuring head 1 for exerting a torque on the head portion 5 of the torque wrench 500. The transducer 5 is adapted to generate measured signals during the operation.

The signal processing unit 2 is electrically coupled to the transducer 10 of the measuring head 1 for processing the measured signals of the transducer 10. The communication unit 33 associates with a data storage 7 in the torque wrench 500 for a data exchange therebetween, and reads out the data storage 7 of the torque wrench 500 for obtaining a preset torque of the torque wrench 500 for a release. The calibration unit 32 connects the signal processing unit 2 and the communication unit 33 to adjust or correct the torque wrench 500 by comparison of the torque exerted in the moment of the release to the preset torque at the torque wrench 500.

In the illustrated embodiment, the communication unit 33 is coupled to the data storage 7 of the torque wrench 500 by means of cables 9. However, it will be appreciated that other connecting methods could be utilized. For example, the communication unit 33 may be wirelessly connected to the data storage 7 of the torque wrench 500.

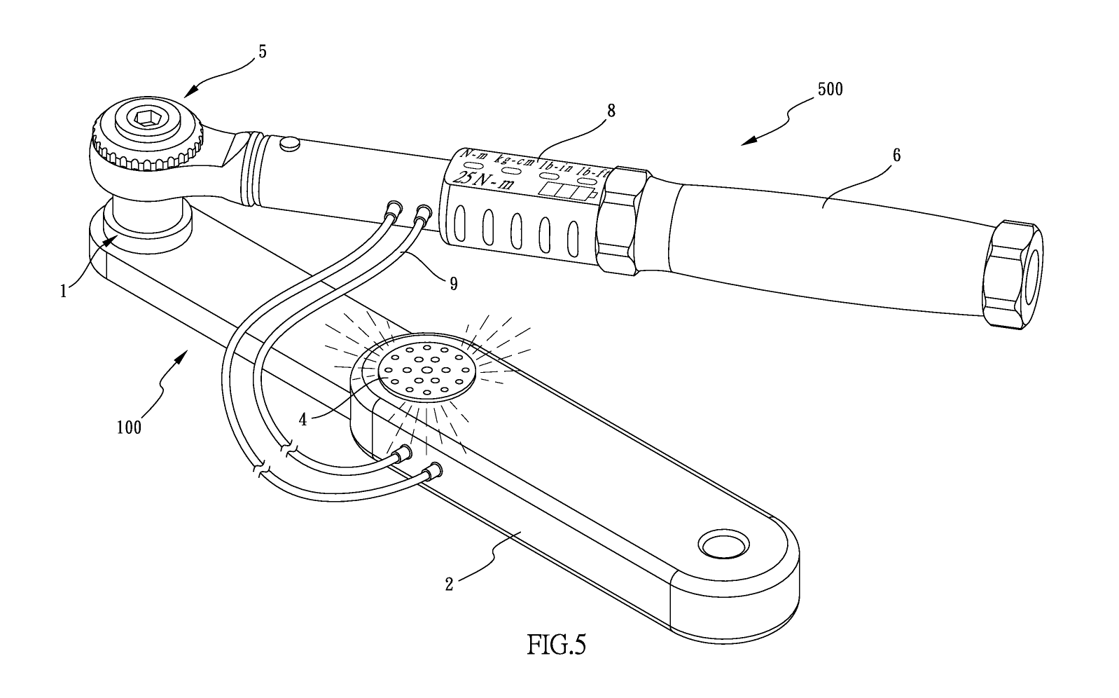

Besides, an alarm 4 may be employed at the calibration tool 100 and particularly at the deflecting lever 2 to make a sound in the moment of the release of the torque wrench 500, as shown in FIG. 5.

It is appreciated that the transducer 10, the signal processing unit 22, as well as certain other internal parts or mechanisms of the calibration tool 100, are not specifically illustrated or described in detail, as they may be of a conventional nature and do not represent an essential feature of the present invention, except in so far as they relate to the application of a torque load to the torque wrench 500 being tested.

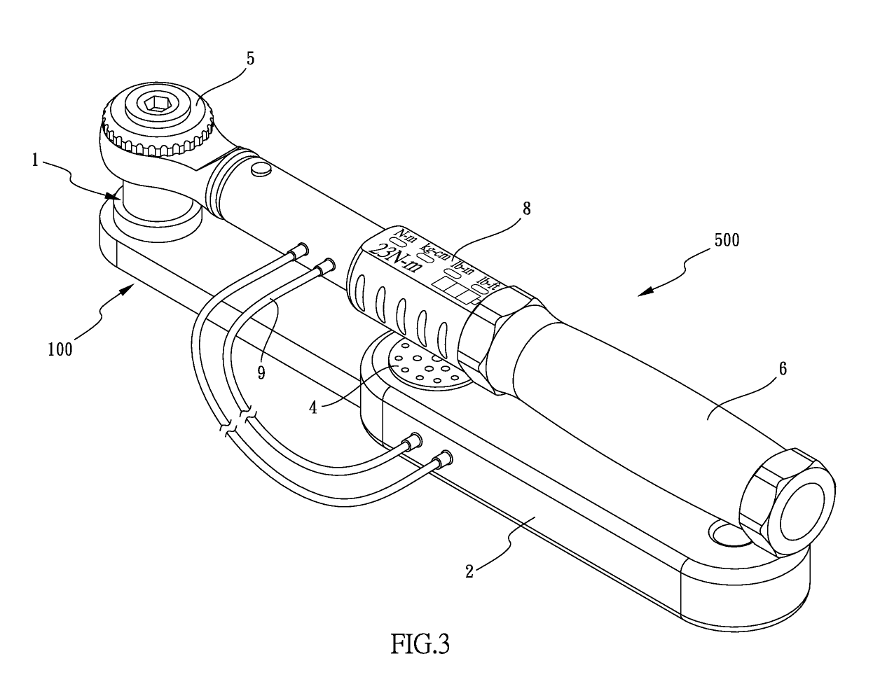

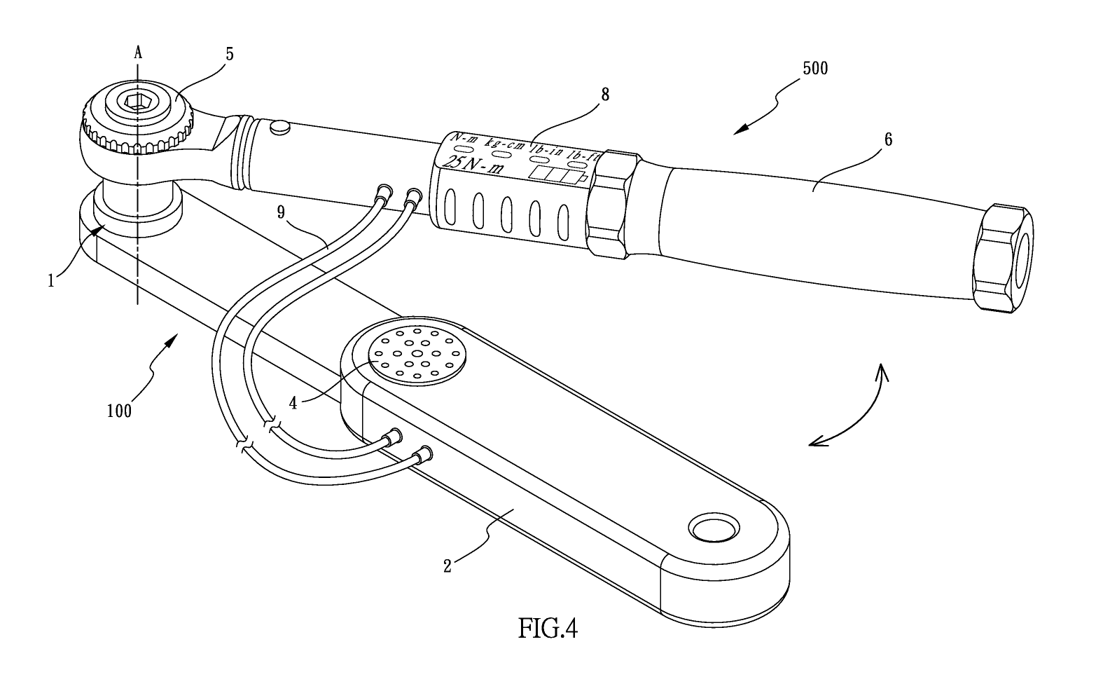

In order to test the accuracy of the torque wrench 500, the torque wrench 500 is engaged with the calibration tool 100 as depicted in FIG. 3, and a torque is preset by the user on the torque wrench 500. Then, with a reception 101 provided at the transducer 10, the square drive 51 of the head portion 5 of the torque wrench 500 is fixed to the transducer 10 by square fitting. Afterwards, as depicted in FIG. 4, the grip 6 of the torque wrench 500 and the deflecting lever 2 of the calibration tool 100 are pivoted with respect to one another at a pivot axis A to exert torque onto the head portion 5 of the torque wrench 500 and to finally get a maximum exerted torque before a release of the torque wrench 500. Besides, in the moment of the release, the alarm 4 is actuated to make a sound, as depicted in FIG. 5, to indicate the reaching of a given torque. At this time, the calibration unit 32 compares the actual torque exerted on the head portion 5 to the preset torque displayed on a display 8 of the torque wrench 500 for the calibration.

It is appreciated that the measured torque valve measured by the transducer 10 may also be shown on the display 8 of the torque wrench 500 for comparison by the user. Moreover, the calibration unit 32 may also automatically replace the preset torque of the electronic torque wrench in the data storage 7 with the measured torque exerted in the moment of the release for easy and quick calibration.

As described above, the present invention is directed to a calibration tool that is simple in construction and portable for convenient use.

What is claimed is:

1. A tool for calibrating a torque wrench, comprising:
a measuring head with a transducer configured to have a head portion of the torque wrench coupled thereto, the transducer generating measured signals during the calibration;
a deflecting lever extending from the measuring head for exerting a torque on the head portion of the torque wrench;
a signal processing unit disposed on the deflecting lever and electrically coupled to the transducer for processing the measured signals of the transducer;
a communication unit disposed on the deflecting lever and associated with a data storage of the torque wrench for a data exchange therebetween, wherein the communication unit reads out the data storage of the torque wrench for obtaining a preset torque of the torque wrench for a release; and
a calibration unit disposed on the deflecting lever and configured to calibrate the torque wrench by comparison of the torque exerted in the moment of the release to the preset torque at the torque wrench.

2. A calibration tool as recited in claim 1, further comprising an alarm that is disposed on the deflecting lever and set to make a sound in the moment of the release.

3. A calibration tool as recited in claim 1, wherein the communication unit is wirelessly connected to the data storage of the torque wrench.

4. A calibration tool as recited in claim 1, further comprising at least one cable for connection of the communication unit and the data storage of the torque wrench.

5. A calibration tool as recited in claim 1, wherein when the calibration unit calibrates the torque wrench, the calibration unit replaces the preset torque of the torque wrench in the data storage with the measured torque exerted in the moment of the release.

6. A torque tool set, comprising an electronic torque wrench and a calibration tool for calibrating the electronic torque wrench, wherein the calibration tool includes:
a measuring head with a transducer configured to have a head portion of the electronic torque wrench coupled thereto, the transducer generating measured signals during the calibration;
a deflecting lever extending from the measuring head for exerting a torque on the head portion of the electronic torque wrench;
a signal processing unit disposed on the deflecting lever and electrically coupled to the transducer for processing the measured signals of the transducer;
a communication unit disposed on the deflecting lever and associated with a data storage of the electronic torque wrench for a data exchange therebetween, wherein the communication unit reads out the data storage of the electronic torque wrench for obtaining a preset torque of the electronic torque wrench for a release; and
a calibration unit disposed on the deflecting lever and configured to calibrate the electronic torque wrench by comparison of the torque exerted in the moment of the release to the preset torque at the electronic torque wrench.

7. A calibration tool as recited in claim 6, further comprising an alarm that is disposed on the deflecting lever and set to make a sound in the moment of the release.

8. A torque tool set as recited in claim 6, wherein the communication unit is wirelessly connected to the data storage of the electronic torque wrench.

9. A torque tool set as recited in claim 6, further comprising at least one cable for connection of the communication unit and the data storage of the electronic torque wrench.

10. A torque tool set as recited in claim 6, wherein when the calibration unit calibrates the electronic torque wrench, the calibration unit replaces the preset torque of the electronic torque wrench in the data storage with the measured torque exerted in the moment of the release.

11. A torque tool set as recited in claim 6, wherein the measured signals of the transducer are shown on a display of the electronic torque wrench.
